(19) United States
(12) Patent Application Publication
(10) Pub. No.: US 2006/0197652 A1
(43) Pub. Date: Sep. 7, 2006

(54) Method and system for proximity tracking-based adaptive power control of radio frequency identification (RFID) interrogators

(75) Inventors: Stefan G. Hild, Somers, NY (US); Paul A. Moskowitz, Yorktown Heights, NY (US); Johnathan M. Reason, White Plains, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/071,174

(22) Filed: Mar. 4, 2005

(51) Int. Cl. H04Q 5/22

(52) U.S. Cl. 340/10.2; 340/10.3

(57) ABSTRACT

A radio frequency identification (RFID) system (and method), includes at least one RFID reader to read at least one RFID tag, a sensor for determining a proximity parameter for the at least one tag with respect to the at least one reader, and a controller that controls the RF power of the at least one reader.

### BACKGROUND OF THE INVENTION

1. Field of the Invention

The present invention generally relates to a method and system for power control of radio frequency identification (RFID) interrogators, e.g., readers, and more particularly to a method and system for proximity tracking based adaptive power control of RFID interrogators.

2. Description of the Related Art

RFID is a technology that employs tags (e.g., wireless radio transponders), attached to a material or object. The tag sends information stored on the tag in response to a radio signal from a reader, which reads the information and forwards it to other systems for subsequent processing. Passive tags do not include transmitters, but send their information as they reflect the radio signal received from the reader back to the reader.

Typically, in logistics applications, tags are attached to materials or objects and detected by fixed readers in order to support automated material identification and tracking. In general, tagged objects may include inanimate objects such as pallets, cases, and individual retail items, but may also include vehicles, people, animals, etc.

In environments containing many Radio Frequency Identification Interrogators (henceforth referred to as “RFID readers”), the rate and range at which an RFID reader identifies RFID tags can be severely compromised by interference from neighboring reader transmissions. This may occur, for example, in the case of retail supply chain distribution centers where many loading docks are placed side-by side. Each loading dock may have many readers leading to interference between readers for the same, adjacent, nearby loading docks. If RFID tagging is used for retail items (e.g., as a bar code replacement), then point-of-sale (POS) terminals must be equipped with RFID readers. The interference problem for adjacent and nearby check-out lanes is then similar to the loading dock problem described above.

This interference occurs when two or more neighboring readers transmit simultaneously or when responses from RFID tags collide with neighboring reader transmissions.

The conventional approach to combating this interference problem is to employ traditional high-complexity radio medium access concepts such as time diversity or frequency diversity such as: time-division multiple-access (TDMA), frequency-division multiple-access (FDMA), and frequency-hopping spread spectrum (FHSS).

Furthermore, all of these techniques require significant added complexity to manage and coordinate time slot, frequency slot, or hopping pattern assignments. Frequency hopping becomes increasingly ineffective for avoiding interference as the number of readers approaches the number of frequency slots available for hopping.

One method for controlling reader power is to turn off the electric power, supplied to enable the function of an individual reader, when the reader is not needed. This helps to satisfy regulatory requirements on duty cycle, but does not address the interference problem if multiple readers must be used simultaneously.

Thus, prior to the present invention, there has been no low-complexity reader radiated RF power variation technique that effectively addresses the problem of having many readers whose transmissions can cause mutual interference.

### SUMMARY OF THE INVENTION

In view of the foregoing and other exemplary problems, drawbacks, and disadvantages of the conventional methods and structures, an exemplary feature of the present invention is to provide a method (and structure) for performing proximity tracking-based adaptive power control of RFID interrogators.

In a first exemplary aspect of the present invention, a radio frequency identification (RFID) system (and method), includes at least one RFID reader to read at least one RFID tag, at least one sensor for determining a proximity parameter for the at least one tag with respect to the at least one reader, and a controller that controls the RF power of the at least one reader.

Additionally, a signal bearing medium storing a program of instructions related to the inventive method is provided.

Thus, the present invention provides a low-complexity adaptive power control technique to mitigate interference in dense RFID reader configurations. This technique includes means to track a proximity parameter (e.g., the distance between the reader and the object that is labeled with an RFID tag such as, for example, a pallet), and a control algorithm that adjusts or varies the power level of the radiated antenna RF power of the reader in accordance with the measured distance to the object. For example, as the object moves closer to the reader, the radiated reader power can be reduced, thereby limiting the interference to neighboring readers.

Additionally, it is another exemplary feature of the present invention to provide a means and a method to adjust the radiated RF power level of an individual RFID reader based upon other proximity parameters (e.g., the relative motion, direction and speed) of the tagged object as it moves toward or away from the reader.

It is also an exemplary feature to adjust reader power based upon additional quality metric factors including RF signal strength returned to the reader and/or a count of the number of tags read.

Further, it is another exemplary feature of the present invention to provide a means and method for adjusting the power levels of arrays of multiple RFID readers based upon the proximity parameters of more than one tagged object.

In comparison to conventional solutions, the present invention can coexist with existing solutions (e.g., frequency hopping, etc.) and also can provide the useful artifact of determining additional information about the tagged object (e.g., the position of and the direction in which the object is moving, such as for example, leaving or entering a warehouse).

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary RFID system 100 according to the present invention;

FIG. 2 illustrates a block diagram of a system 200 used to enable the present invention;

FIG. 3 illustrates a flowchart of a method 300 for practicing the present invention; and

FIG. 4 illustrates a storage medium 400 for storing a program for practicing the method 300 of the invention.

### DETAILED DESCRIPTION OF EXEMPLARY EMBODIMENTS OF THE INVENTION

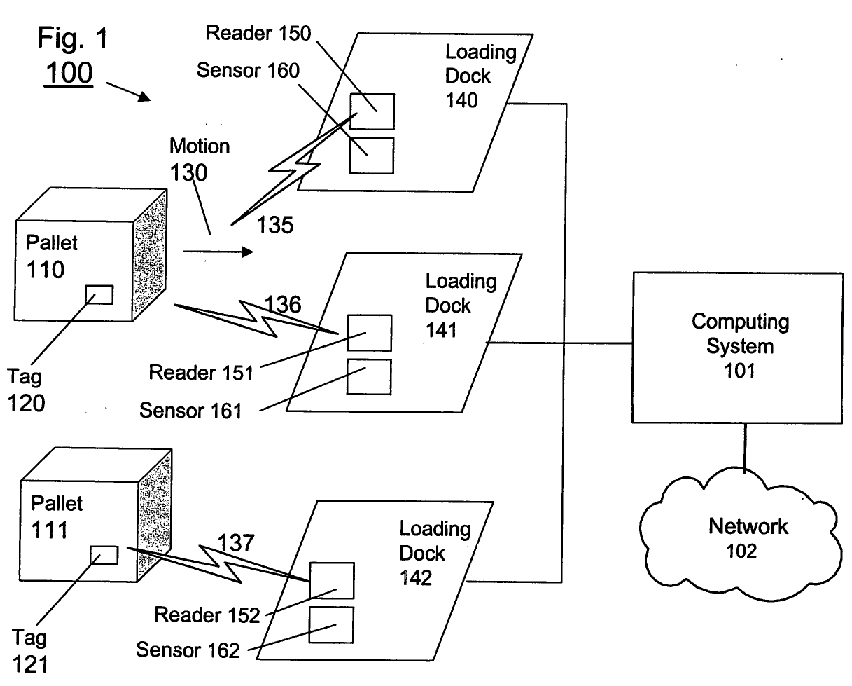

Referring now to the drawings, and more particularly to FIGS. 1-4, there are shown exemplary embodiments of the method and structures according to the present invention.

### Exemplary Embodiment

An RFID system 100 that implements the invention is shown in FIG. 1. System 100 illustrates the invention for an exemplary application of a supply chain distribution center where many loading dock doors may be arrayed next to one another.

As would be evident to one of ordinary skill in the art taking the present application as a whole, the invention is not limited to this application and indeed can be practiced in many different environments and applications. For example, the invention may similarly be employed for a retail store point-of-sale check-out system, for an electronic toll collection system, for a customer service counter, etc. For the last three examples, the tagged objects may be retail items, vehicles, or people, respectively.

FIG. 1 depicts a series of loading dock doorways 140, 141, and 142. Each doorway has at least one RFID reader 150, 151, 152, respectively, associated with it. RFID readers are commercially available and are manufactured for this application by various companies including: Intermec®, Matrics®, Alien®, AWID®, Samsys®, ThingMagic®, etc.

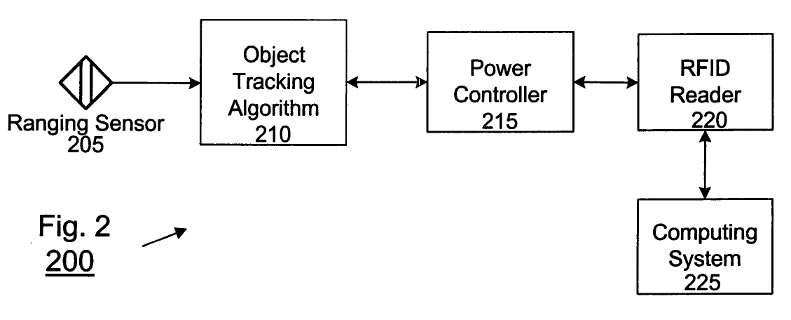

Additionally, there is at least one sensor 160, 161, 162, respectively, associated with each doorway 140, 141, 142. The sensor may include a sonar system, a radar system, a laser device, an infrared device, or an imaging system. Exemplary sensors are shown in FIG. 2 and are described in further detail below.

Each reader may be an RFID reader capable of reading at least one RFID tag, but usually capable of reading more than one tag, e.g capable of reading several tags simultaneously. Tags for this application are manufactured by companies including: Intermec®, Matrics®, Alien®, and Texas Instruments®.

The tags 120 and 121 placed upon pallets 110 and 111 are read by wireless radio communications, 135, 136, 137, between the readers and the tags. The pallets may be stationary or may be in motion 130 with respect to the readers 150, 151, 152.

As the tagged objects (e.g., the pallets) approach the loading docks, the sensors 160, 161, 162 determine proximity parameters associated with the tagged objects. The proximity parameters include distance, speed, direction of motion, etc. The readers obtain information from tags placed upon the objects.

The information may include an object type (e.g., pallet, case, or item), a manufacturer's code, a product code, and a serial number, as well as other information. A single pallet may have many tagged objects, cases, etc. associated with it.

For example, there may be many cases resting on the pallet, each with its own RFID tag. In addition to the information contained in an individual tag, the readers may record and send to the computing system 101 other quality metric information, such as the strength of the signal received by the reader from a tag, a count of the number of tags read by the reader, etc.

Information from the readers 150, 151, 152 and the sensors 160, 161, 162 is transmitted to a computing system 101. Each reader may have its own computing system or an array of readers may use a single computing system. The computing system 101 may be coupled to other computing systems by a network 102. The network 102 may be wired or wireless including any of Ethernet, Bluetooth, Wi-Fi, etc.

The information received by the computing system 101 from the tags 120, 121 and the readers 150, 151, 152 may be used to adjust the radiated RF power output of the readers. The RF power output may be varied continuously or in steps as commands are received by the readers from the computing system 101. An example of an RFID reader whose RF power may be varied is the Tagsys L200 High Frequency reader.

FIG. 2 illustrates a block diagram of another system 200 of the present invention. The system includes a ranging sensor 205, an object tracking algorithm 210, a power controller 215, an RFID reader 220, and a computing system 225, each described in detail below.

The ranging sensor 205 periodically produces a physical measurement that can be used to calculate the range to the object in its field-of-view (FOV). One common measurement is time-of-flight (TOF), which is the propagation time for an electromagnetic (e.g., infrared) or mechanical wave (e.g., ultrasonic) to travel from the ranging sensor 205, reflect off the object in the field-of-view, and then travel back to the ranging sensor 205. From TOF, it is trivial to calculate the distance to the object in the FOV of the ranging sensor 205. This is true because the speed of electromagnetic and mechanical waves is well known. For example, the speed of an ultrasonic sound wave in air is approximately 330 meters per second, and the speed of an electromagnetic wave in air is approximately 300,000,000 meters per second.

Ranging sensors are typically implemented using wireless technologies such as sonar, radar, laser, infrared, and optical devices. Examples of TOF-based ranging sensors are the SensComp 600 sonar module and the Sharp GP2YA02YK infrared module.

The object tracking algorithm 210 uses the ranging sensor's physical measurement of range to compute a proximity parameter. This proximity parameter can be any tuple of the kinematical quantities of the object's motion, which include distance, speed, direction, and time. As we have stated, it is trivial to calculate distance from TOF measurements. Additionally, by maintaining a small history of past distance calculations and the time between successive TOF measurements, the object tracking algorithm can also compute (or predict) the speed and direction of the object.

The power controller 215 uses the proximity parameter to compute the RFID reader's transmitter power level, and it determines whether the reader should update its power level. This update decision process is necessary because not all power level computations will result in a power level update.

Consider a slow moving object (e.g., 1 centimeter per second) in comparison to an object moving faster (e.g., 1 meter per second). The slow moving object will require less frequent power level updates because the range to the object is changing at a slower rate. Additionally, the power controller 215 can refine its power level computation by using the RFID reader's feedback about its quality of reception of responses from one or more RFID tags.

The computing system 225 includes one or more computers that are connected to a backbone network. The primary functions of the computing system is to provide a means for logging RFID tag responses, to coordinate adaptive power controller across multiple readers, and to provide system management functions (e.g., turn-on and turn-off).

While FIG. 2 illustrates the above-described components (e.g., the ranging sensor 205, the object tracking algorithm 210, the power controller 215, and the computing system 225) of the invention as independent of the RFID reader 220, this does not preclude other configurations.

That is, components 205, 210, and 215 could be wholly or partially contained within the RFID reader 220 or within the computing system 225. The logic that supports the object tracking algorithm 210 and the power controller 215 can be executed on a small 8-bit microcontroller. Thus, the 32-bit microcontrollers that reside in most state-of-the-art RFID readers and computers are more than sufficient. The invention is compatible with any type of ranging sensor that provides measurements (e.g., TOF, etc.) that can be transformed into a suitable proximity parameter.

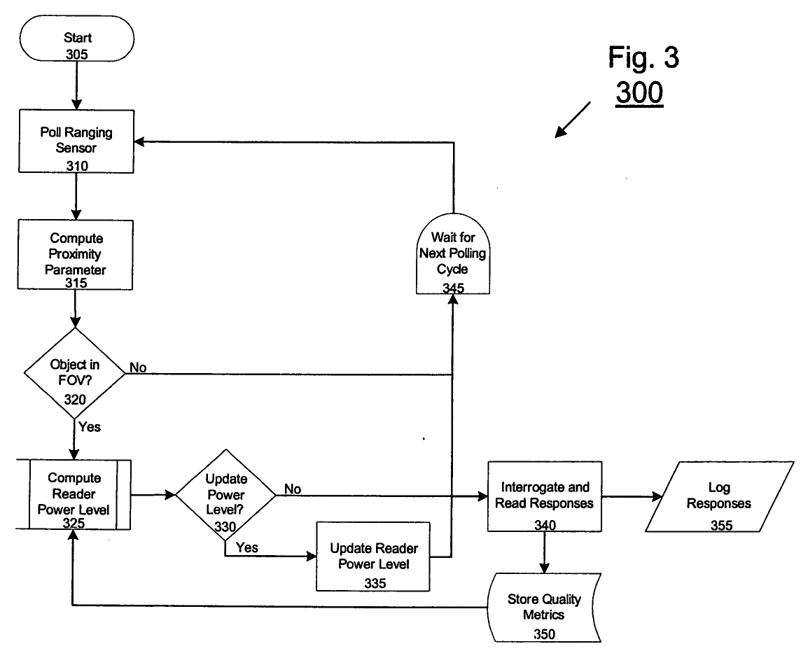

FIG. 3 illustrates a flowchart of a method 300 for practicing the present invention.

In FIG. 3, the method starts in step 305. Then, a ranging sensor is polled periodically for its range measurement (step 310). The range measurement could be the 2-tuple {TOF, timestamp} where timestamp is a representation of the time the measurement was taken. This 2-tuple is passed to the object tracking algorithm, which computes the proximity parameter (step 315), which could be the 3-tuple {e.g., distance, speed, direction}.

The object tracking algorithm then determines if the object is in the FOV of the RFID reader (step 320). For example, the criteria for being in the reader's FOV might be a distance less than 9 meters and moving in a direction that is bringing the object closer to the reader.

If the object is not in the reader's FOV (e.g., a “NO” in step 320), then process flow stops and waits for the next polling cycle (step 345) and the process returns to step 310.

If the object is in the reader's FOV (e.g., a “YES” in step 320), then the proximity parameter is passed to the power controller. The power controller then computes a new transmitter power level (step 325) (as described below) for the RFID reader, and determines if the new power level is appreciably different from the previous computed power level (step 330).

If there is an appreciable difference, e.g., five percent, then the RFID reader's power level is updated (step 335). Otherwise, the process flow continues with the next step, which is for the reader to interrogate one or more RFID tags on the object and then read one or more responses from the tags (step 340). The process flow then waits for the next polling cycle 345. During each polling cycle, each process just described is repeated until the object exits the RFID reader's FOV. When this event occurs, the process flow reduces to steps 310, 315, 320, and 345.

While there is an object in its FOV, the RFID reader will repeat the process of interrogation and reading responses (step 340).

Additionally, the RFID reader will store metrics that describe the reception quality of the RFID tag responses (step 350) and log the tag responses (step 355). The received signal strength of one or more tag responses and the total tag count are examples of quality metrics.

As a refinement, quality metrics (step 350) can be fed back to the power level computation (step 325). That is, the invention can selectively reduce or turn off the radio frequency wave radiation output based on quality metrics 350 being fed back.

The logging process provides RFID applications with the information to track the progress of one or more tags as they traverse an RFID reader location along their journey from source to destination (e.g., from supplier to retailer). The computing system typically will provide the logging medium, which could be a database store.

One method for computing the RFID transmitter power level is as follows.

First, choose a target value for the received signal power for the reception of the interrogation signal at one or more RFID tags on the object in the FOV.

Then, as the object moves through the FOV, the power controller can adapt the RFID reader transmitter such that the estimated received signal power meets or exceeds the target value. It is well known in the art that RF power in free space with line-of-sight to the receiver attenuates inversely proportionally to the squared distance between transmitter and receiver.

Thus, given the distance to the object in the RFID reader's FOV and the RFID transmitter power and other characteristics (e.g., antenna gain, carrier frequency, etc.), closed form mathematical expressions are known (or can be derived) to estimate the received signal power at the RFID tag.

Additional information such as speed and direction can enable predictive capabilities. For example, instead of providing a single update for power level, the power controller could compute a schedule of updates that tells the reader what power level to use and at what time. The quality metrics are physical measurements that provide the power controller with feedback on the accuracy of its estimate for the RFID tag received signal power.

The system and method described above is also capable of coordinating adaptive power control across multiple readers. Consider the scenario where one or more RFID readers are tracking the same object. If each system logs its proximity parameter and quality metrics with the computing system, then the computing system will have a global view of the variables affecting each independent power controller. Thus, the computer system could selectively deactivate the redundant tracking of the same object except for the system(s) providing the best tracking. Hence, as mentioned above, the invention can selectively reduce or turn off the radio frequency wave radiation output based on quality metrics 350 being fed back.

A different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

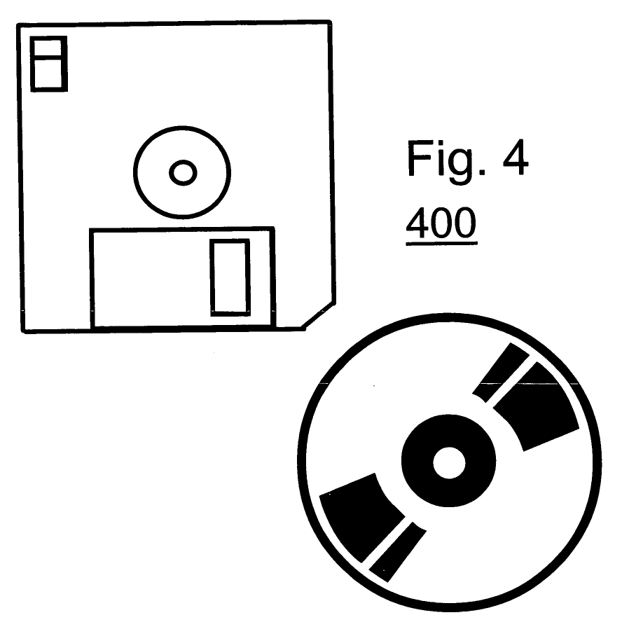

This signal-bearing media may include, for example, a RAM contained within the computing system 225 (e.g., a central processing unit (CPU), as represented by the fast-access storage for example. Alternatively, the instructions may be contained in another signal-bearing media, such as a magnetic data storage or CD-ROM diskette 400 (FIG. 4), directly or indirectly accessible by the CPU. Thus, FIG. 4 illustrates a storage medium 400 for storing a program for practicing the method 300 of the invention.

Whether contained in the diskette 400, the computer/CPU, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several exemplary embodiments, those skilled in the art will recognize that the invention can be practiced with modification within the spirit and scope of the appended claims.

For example, this invention does not only apply to RFID devices, but also to other network devices such as “smart dust” or “motes” (e.g., ZigBee® devices) which may conform to IEEE 802.15.4.

Further, it is noted that, Applicants' intent is to encompass equivalents of all claim elements, even if amended later during prosecution.

What is claimed is:

1. A radio frequency identification (RFID) system, comprising:
at least one RFID reader to read at least one RFID tag;
a sensor for determining a proximity parameter for said at least one tag with respect to said at least one reader; and
a controller that controls the RF power of said at least one reader.

2. The system of claim 1, wherein said proximity parameter comprises one of distance, speed, and direction of motion.

3. The system of claim 1, wherein said sensor comprises one of a sonar system, a radar system, a laser device, an infrared device, and an imaging system.

4. The system of claim 1, wherein said at least one reader comprises a plurality of readers.

5. The system of claim 4, further comprising:
at least one computing system for controlling said plurality of readers to vary the RF power levels of said readers over a range of values.

6. The system of claim 5, wherein said at least one computing system comprises a plurality of computing systems communicating with one another over a network.

7. The system of claim 1, wherein said controller controls the power of said at least one reader by employing a value of said proximity parameter.

8. The system of claim 1, wherein said controller controls the power of said at least one reader by employing a schedule of updates.

9. The system of claim 7, wherein said controller controls the power of said at least one reader by further employing a quality metric.

10. The system of claim 9, wherein said quality metric comprises one of a strength of a signal received by said at least one reader from said at least one tag and a count of the number of tags read by said reader.

11. The system of claim 9, wherein said controller receives information regarding the quality metric to control the power.

12. The system of claim 1, wherein said RFID system is employed in one of a supply chain distribution center, retail store point-of-sale check-out system, electronic toll collection system, and a customer service counter.

13. The system of claim 1, wherein said controller further comprises means for varying the power level over a range of values.

14. The system of claim 1, further comprising a logging unit that provides information to track the progress of RFID tags.

15. A method of using a radio frequency identification (RFID) system, comprising:
reading at least one RFID tag by an RFID reader;
determining a proximity parameter for said at least one RFID tag with respect to said at least one reader using a sensor; and
controlling the RF power of said at least one reader.

16. The method of claim 15, wherein said proximity parameter comprises one of distance, speed, and direction of motion.

17. The method of claim 15, wherein said at least one reader comprises a plurality of readers, said method further comprising:
controlling said plurality of readers to vary the RF power levels of said readers over a range of values.

18. The method of claim 15, wherein said controlling comprises controlling the power of said at least one reader by employing a value of said proximity parameter.

19. The method of claim 15, wherein said controlling controls the power of said at least one reader by employing a schedule of updates.

20. A signal-bearing medium tangibly embodying a program of machine-readable instructions executable by a digital processing apparatus to perform a method of using a radio frequency identification (RFID) system, comprising:
reading at least one RFID tag by an RFID reader;
determining a proximity parameter for said at least one RFID tag with respect to said at least one reader using a sensor; and
controlling the RF power of said at least one reader.
